(19) United States
(12) Patent Application Publication
(10) Pub. No.: US 2023/0071190 A1
(43) Pub. Date: Mar. 9, 2023

(54) TECHNIQUE FOR SUPPRESSING MOTOR FAILURE IN BLOWER

(71) Applicant: MAKITA CORPORATION, Anjo-shi (JP)

(72) Inventors: Yuki KAWAI, Anjo-shi (JP); Naoya ASAMI, Anjo-shi (JP)

(73) Assignee: MAKITA CORPORATION, Anjo-shi (JP)

(21) Appl. No.: 17/899,363

(22) Filed: Aug. 30, 2022

(30) Foreign Application Priority Data
Sep. 3, 2021 (JP) 2021-144116
Aug. 23, 2022 (JP) 2022-132826

(51) Int. Cl. F04D 25/06; H02K 7/14; H02P 3/06; H02P 23/14

(52) U.S. Cl. CPC F04D 25/0666; H02K 7/145; H02P 3/06; H02P 23/14

(57) ABSTRACT

A blower in one aspect of the present disclosure includes: a housing including a suction port and a discharge port; a motor in the housing; a fan in the housing; a motor drive circuit; and a control circuit. The control circuit detects an insufficient airflow from the suction port to the discharge port based on an operation parameter. The operation parameter is associated with an operation of the motor.

### CROSS-REFERENCE TO RELATED APPLICATIONS

The present application claims the benefit of Japanese Patent Application No. 2021-144116 filed on Sep. 3, 2021 with the Japan Patent Office and Japanese Patent Application No. 2022-132826 filed on Aug. 23, 2022 with the Japan Patent Office, the entire disclosure of Japanese Patent Application No. 2021-144116 and the entire disclosure of Japanese Patent Application No. 2022-132826 are incorporated herein by reference.

### BACKGROUND

The present disclosure relates to a blower.

Japanese Unexamined Patent Application Publication No. 2021-076098 discloses a blower that blows out dust and the like with a compressed air.

### SUMMARY

The blower as described above can draw an air from a pneumatically inflated structure, such as a floating tube, to thereby deflate the pneumatically inflated structure, if an air needle is connected to an air suction port of the blower and is inserted into the pneumatically inflated structure.

In a case in which the blower is used as a deflator, when the air is completely evacuated from the pneumatically inflated structure, there is no longer airflow flowing into the blower. Consequently, a load applied to the motor decreases, and a rotational frequency of the motor abruptly increases. In addition to that, heat generated in the motor is not released from the blower. If the motor is kept operating in such a circumstance, a failure may be generated in the motor.

In one aspect of the present disclosure, it is desirable to suppress a motor failure generated in a blower due to the blower being used to draw an air from a pneumatically inflated structure.

One aspect of the present disclosure provides a blower including a housing, a motor in the housing, a fan in the housing, a motor drive circuit, and a control circuit. The housing includes a suction port and a discharge port. The suction port and the discharge port communicate an inside of the housing with an outside of the housing. The fan is rotationally driven by the motor to thereby generate an airflow from the suction port to the discharge port. The motor drive circuit receives an electric power and drives the motor based on the electric power received. The control circuit detects an insufficient airflow (or an insufficient air) from the suction port to the discharge port based on an operation parameter. The operation parameter is associated with an operation of the motor.

The blower as described above can detect the insufficient airflow. This allows a user of the blower to take a preventive measure for suppressing a motor failure due to the insufficient airflow.

Another aspect of the present disclosure provides a method including: driving a motor of a blower; and detecting an insufficient airflow in a housing of the blower based on an operation parameter, the operation parameter being associated with an operation of the motor.

The method as described above makes it possible to detect the insufficient airflow. This allows the user of the blower to take the preventive measure for suppressing the motor failure due to the insufficient airflow.

### BRIEF DESCRIPTION OF THE DRAWINGS

An example embodiment of the present disclosure will be described hereinafter by way of example with reference to the accompanying drawings, in which:

FIG. 1 is a perspective view of a blower according to an example embodiment, as seen from a diagonally upper forward position;

FIG. 2 is a perspective view of the blower, as seen from a diagonally upper rearward position;

FIG. 3 is a perspective view of the blower with a nozzle attached;

FIG. 4 is a perspective view of the blower with an air suction hose attached;

FIG. 5 is a sectional view of the blower;

FIG. 6 is a block diagram showing an electrical configuration of the blower;

FIG. 7 is a block diagram showing a detailed circuit configuration of a motor drive circuit;

FIG. 8 is a flow chart showing a flow of a blower control process;

FIG. 9A is a flow chart showing a flow of a part of a motor control process;

FIG. 9B is a flow chart showing a flow of the rest of the motor control process;

FIG. 10 is a flow chart showing a flow of a soft-start process;

FIG. 11 is a graph showing a relation between a trigger level and a designated power;

FIG. 12 is a flow chart showing a flow of an overspeed suppression process;

FIGS. 13A and 13B each show a graph indicating respective variations in an actual rotational frequency and in an output duty ratio over time; and

FIG. 14 shows a graph to explain a detection of an insufficient airflow.

### DETAILED DESCRIPTION OF EXEMPLARY EMBODIMENTS

### 1. Overview of Embodiments

One embodiment may provide a blower (or an inflator) including at least any one of the following features 1 through 6:
Feature 1: a housing including a suction port and a discharge port, the suction port and the discharge port communicating an inside of the housing with an outside of the housing;
Feature 2: a motor in the housing;
Feature 3: a fan (i) in the housing and (ii) configured to be rotationally driven by the motor to thereby generate an airflow from the suction port to the discharge port;
Feature 4: a motor drive circuit configured (i) to receive an electric power and (ii) to drive the motor based on the electric power received;
Feature 5: a control circuit configured to detect an insufficient airflow (or an insufficient air) from the suction port to the discharge port based on an operation parameter;
Feature 6: the operation parameter is associated with an operation of the motor.

The blower including at least the features 1 through 6 can detect the insufficient airflow. This allows a user of the blower to take a preventive measure for suppressing a motor failure due to the insufficient airflow.

The operation parameter may be any parameter that is associated with the operation of the motor.

One embodiment may include, in addition to or in place of at least any one of the features 1 through 6, at least any one of the following features 7 through 10:
Feature 7: a rotational frequency detection circuit configured to output a rotational frequency signal based on a rotation of the motor;
Feature 8: the rotational frequency signal varies in accordance with an actual rotational frequency of the motor;
Feature 9: the control circuit is configured (i) to receive the rotational frequency signal and (ii) to detect the actual rotational frequency based on the rotational frequency signal;
Feature 10: the operation parameter includes the actual rotational frequency.

The blower including at least the features 1 through 10 can detect the insufficient airflow based on the actual rotational frequency of the motor.

One embodiment may include, in addition to or in place of at least any one of the features 1 through 10, the following feature 11:
Feature 11: a motor unit (i) in the housing and (ii) including the motor, the motor drive circuit, and the rotational frequency detection circuit.

One embodiment may include, in addition to or in place of at least any one of the features 1 through 11, at least any one of the following features 12 through 15:
Feature 12: a current detection circuit configured (i) to detect a magnitude of a drive current flowing through the motor and (ii) to output a current detection signal;
Feature 13: the current detection signal varies in accordance with the magnitude of the drive current;
Feature 14: the control circuit is configured (i) to receive the current detection signal and (ii) to detect the magnitude of the drive current;
Feature 15: the operation parameter includes the magnitude of the drive current.

The blower including at least the features 1 through 6, and 12 through 15 can detect the insufficient airflow based on the magnitude of the drive current.

One embodiment may include, in addition to or in place of at least any one of the features 1 through 15, at least any one of the following features 16 through 18:
Feature 16: the control circuit is configured to output a power designating signal to the motor drive circuit;
Feature 17: the power designating signal varies in accordance with a designated power;
Feature 18: the motor drive circuit is configured to drive the motor in accordance with the power designating signal.

The blower including at least the features 1 through 6, and 16 through 18 can drive the motor in accordance with the designated power. The designated power may be fixed or may be variable.

One embodiment may include, in addition to or in place of at least any one of the features 1 through 18, at least any one of the following features 19 through 21:
Feature 19: the power designating signal is in the form of a pulse width modulation signal;
Feature 20: the control circuit is configured to set an output duty ratio of the power designating signal based on a magnitude of the designated power;
Feature 21: the control circuit is configured to output, to the motor drive circuit, the power designating signal having the output duty ratio.

The blower including at least the features 1 through 6, and 16 through 21 can drive the motor based on the output duty ratio.

One embodiment may include, in addition to or in place of at least any one of the features 1 through 21, the following feature 22 and/or feature 23:
Feature 22: the motor drive circuit is configured to deliver, to the motor, an electric power designated by the power designating signal;
Feature 23: the motor drive circuit is configured to perform a constant power control that maintains a magnitude of the electric power delivered to the motor at a magnitude of the designated power.

In the blower including at least the features 1 through 6, 16 through 18, 22, and 23, when the insufficient airflow occurs and a load applied to the fan, and consequently to the motor decreases, the actual rotational frequency of the motor increases due to the magnitude of the delivered power being maintained at the magnitude of the designated power. Such a blower can certainly detect the insufficient airflow.

One embodiment may include, in addition to or in place of at least any one of the features 1 through 23, at least any one of the following features 24 through 27:
Feature 24: the motor drive circuit is configured to set a drive duty ratio based on the magnitude of the designated power;
Feature 25: the motor drive circuit is configured to output, to the control circuit, a feedback signal indicating the drive duty ratio;
Feature 26: the drive duty ratio affects an effective voltage to be applied to the motor;
Feature 27: the operation parameter includes the drive duty ratio.

The blower including at least the features 1 through 6, 16 through 18, and 22 through 27 can certainly detect the insufficient airflow based on the drive duty ratio.

One embodiment may include, in addition to or in place of at least any one of the features 1 through 27, the following feature 28 and/or feature 29:
Feature 28: a manual switch configured to be moved by a user of the blower to designate a magnitude of an electric power to be delivered to the motor;
Feature 29: the control circuit is configured to vary the power designating signal based on a movement of the manual switch.

In the blower including at least the features 1 through 6, 16 through 18, 28, and 29, the user can vary the power designating signal with the manual switch to thereby vary the magnitude of the electric power to be delivered to the motor.

One embodiment may include, in addition to or in place of at least any one of the features 1 through 29, at least any one of the following features 30 through 32:
Feature 30: the housing includes a suction portion including the suction port;
Feature 31: the suction portion is configured to be detachably attached to an attachment;
Feature 32: the attachment includes an air needle.

The blower including at least the features 1 through 6, and 30 through 32 allows the user to insert the air needle into a pneumatically inflated structure to draw an air from the pneumatically inflated structure.

One embodiment may include, in addition to or in place of at least any one of the features 1 through 32, at least any one of the following features 33 to 35:
Feature 33: the attachment includes an air suction hose;
Feature 34: the air suction hose includes a first end configured to be detachably attached to the suction portion;
Feature 35: the air suction hose includes a second end connected to the air needle.

The blower including at least the features 1 through 6, and 30 through 35 allows the user to insert the air needle into the pneumatically inflated structure distant from the blower, and to draw the air from the pneumatically inflated structure.

One embodiment may include, in addition to or in place of at least any one of the features 1 through 35, the following Feature 36:
Feature 36: the control circuit is configured to control the motor via the motor drive circuit, in response to the control circuit detecting or having detected the insufficient airflow, so as (i) to reduce an actual rotational frequency of the motor or (ii) to stop the motor.

The blower including at least the features 1 through 6 and 36 can reduce the actual rotational frequency or stop the motor, when the insufficient airflow occurs, to thereby suppress the motor failure.

One embodiment may include, in addition to or in place of at least any one of the features 1 through 36, the following feature 37:
Feature 37: the blower is in the form of a handheld blower.

One embodiment may include, in addition to or in place of at least any one of the features 1 through 37, the following feature 38:
Feature 38: a handgrip (i) extending from the housing and (ii) configured to be gripped by a user of the blower.

In one embodiment, the control circuit may be integrated into a single electronic unit, a single electronic device, or a single circuit board.

In one embodiment, the control circuit may be a combination of two or more electronic circuits, of two or more electronic units, or of two or more electronic devices, each of which is individually disposed on the blower or in the blower.

In one embodiment, the control circuit may include a microcomputer.

In one embodiment, the control circuit may include, in place of or in addition to the microcomputer, a combination of electronic components, such as discrete devices, an application specific integrated circuit (ASIC), an application specific standard product (ASSP), a programmable logic device, such as a field programmable gate array (FPGA), or any combination thereof.

Examples of the motor include a brushed DC motor, a brushless DC motor, and an AC motor.

Examples of the motor drive circuit include any forms of bridge circuits including a half-bridge circuit and a full-bridge circuit, and any forms of semiconductor switches.

One embodiment may provide a method including at least any one of the following features 39 through 41:
Feature 39: driving a motor of a blower;
Feature 40: detecting an insufficient airflow in a housing of the blower based on an operation parameter;
Feature 41: the operation parameter is associated with an operation of the motor.

The method including at least the features 39 through 41 makes it possible to suppress a motor failure generated in the blower when an air is completely evacuated from a pneumatically inflated structure with the blower.

One embodiment may include, in addition to or in place of at least any one of the features 39 through 41, the following feature 42 and/or feature 43:
Feature 42: the operation parameter includes an actual rotational frequency of the motor, a magnitude of a drive current flowing through the motor, and/or a drive duty ratio;
Feature 43: the drive duty ratio affects an effective voltage to be applied to the motor.

The method including at least the features 39 through 43 makes it possible to detect the insufficient airflow based on the actual rotational frequency, the magnitude of the drive current, and/or the drive duty ratio.

One embodiment may include, in addition to or in place of at least any one of the features 39 through 43, the following feature 44:
Feature 44: in response to the insufficient airflow being detected, reducing an actual rotational frequency of the motor, or stopping the motor.

The method including at least the features 39 through 41, and 44 makes it possible to suppress the motor failure due to the insufficient airflow.

In one embodiment, the features 1 through 44 may be in any combination.

In one embodiment, any of the features 1 through 44 may be omitted. Examples of the pneumatically inflated structure include, but are not limited to, a floating tube, an inflatable ball, an inflatable pool, an inflatable boat, a balloon, an inflatable toy, a pneumatic tire, an air-supported structure, an air mattress, and a vacuum bag.

### 2. Specific Exemplary Embodiment

A description will be given below of a specific exemplary embodiment.

This specific exemplary embodiment is merely an example, and the present disclosure is not limited to this embodiment and may be implemented in any forms.

2-1. Schematic Structure

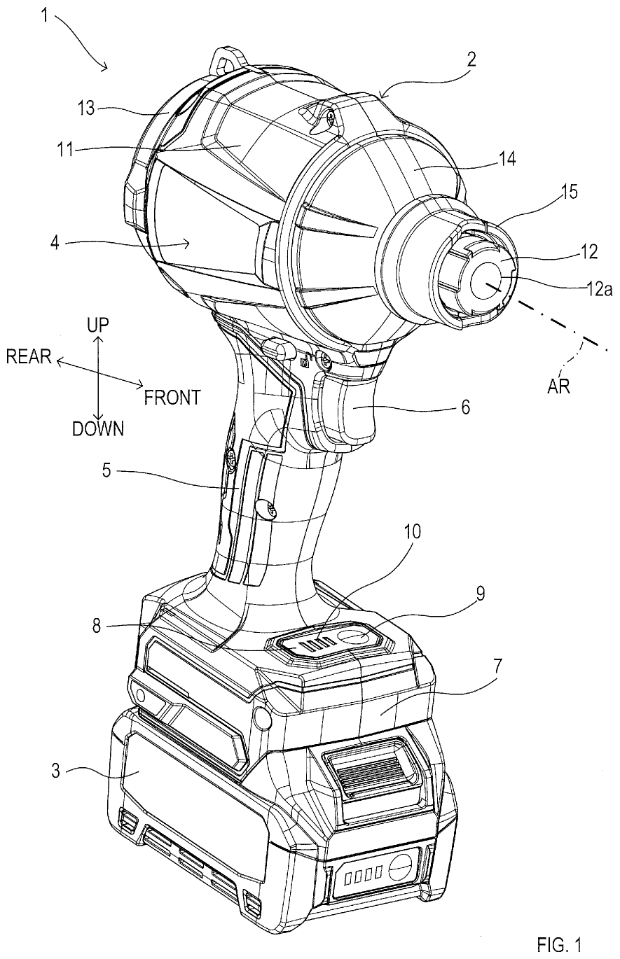

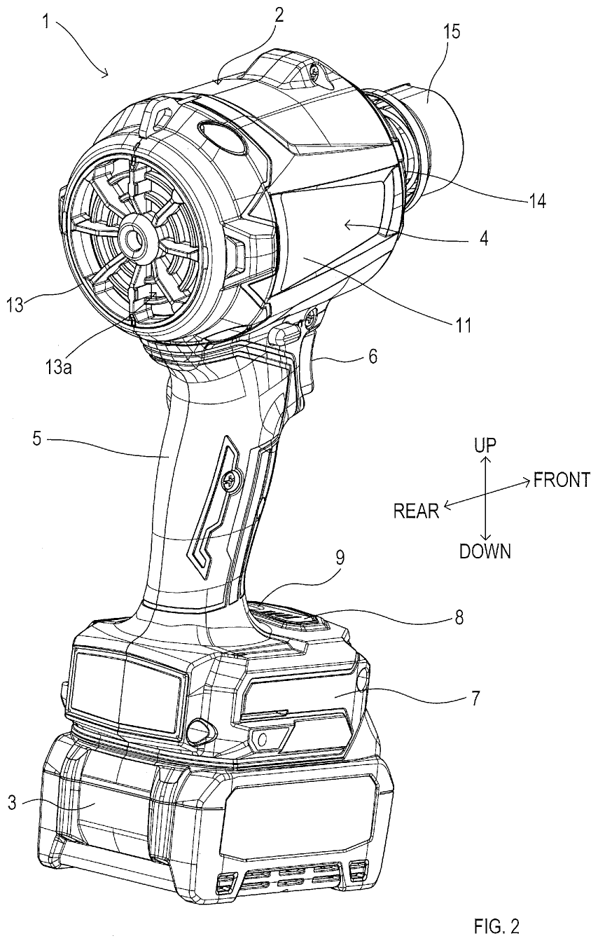

As shown in FIGS. 1 and 2, the present embodiment gives an example of a handheld blower 1 configured to discharge an air to blow dirt, dust and the like away. The blower 1 may be referred to as an air duster in other embodiments.

The blower 1 includes a main body 2. The main body 2 includes a housing 4.

The housing 4 includes a storage 11. In the present embodiment, the storage 11 has a cylindrical shape extending along an axis AR.

The housing 4 includes a discharge portion 12. The discharge portion 12 extends along the axis AR at a position anterior to the storage 11. The discharge portion 12 has a diameter smaller than that of the storage 11. The discharge portion 12 includes a front end that has a first discharge port 12a through which an air is discharged. The axis AR runs through the first discharge port 12a.

The housing 4 includes a suction portion 13. The suction portion 13 covers an opening at a rear end of the storage 11. The suction portion 13 includes two or more first suction ports 13a that penetrate through the suction portion 13 to introduce an air outside the blower 1 into the storage 11.

The housing 4 includes a connector 14. The connector 14 is interposed between the storage 11 and the discharge portion 12, and connects the storage 11 to the discharge portion 12. The connector 14 has a shape of a funnel, and an outer diameter of the connector 14, which is perpendicular to the axis AR, gradually reduces as going from a rear end of the connector 14 toward a front end thereof.

The housing 4 includes an attachment fitting portion 15. The attachment fitting portion 15 surrounds an outer peripheral surface of the discharge portion 12.

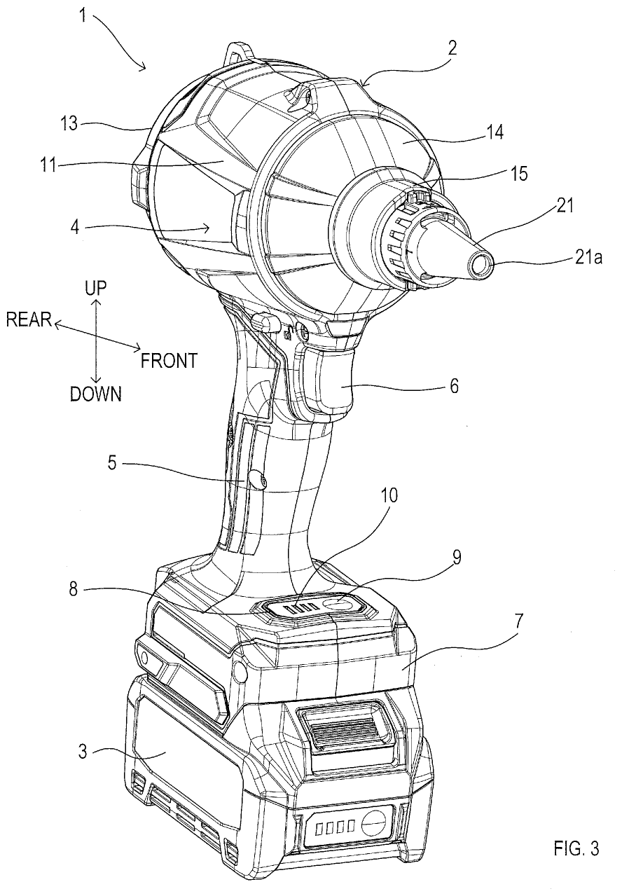

As shown in FIG. 3, the attachment fitting portion 15 is configured to detachably attach a nozzle 21 to the first discharge port 12a. The nozzle 21 includes a second discharge port 21a. The second discharge port 21a has an inner diameter different from that of the first discharge port 12a.

The main body 2 includes a handgrip 5. The handgrip 5 downwardly extends from the housing 4. The handgrip 5 is formed so as to be gripped by a user of the blower 1 in one hand.

The main body 2 includes a trigger 6. The trigger 6 is arranged at an upper frontward position with respect to the handgrip 5 and is manually operated by the user to drive the blower 1. The trigger 6 is arranged so as to be pulled by a finger of the user while the handgrip 5 is gripped by the user.

The main body 2 includes a battery attachment part 7. The battery attachment part 7 is arranged at a lower end of the handgrip 5. A battery pack 3 is detachably attached to the battery attachment part 7. The battery pack 3 supplies a DC power to the main body 2.

The main body 2 includes an operation panel 8. In the present embodiment, the operation panel 8 is arranged on the battery attachment part 7.

The operation panel 8 includes a mode changeover switch 9. The mode changeover switch 9 is manually operated by the user to select operation modes of the blower 1. In the present embodiment, the mode changeover switch 9 is configured to be pressed by the user. The mode changeover switch 9 may include a tactile switch and may be in an ON state only while the user presses and holds down the mode changeover switch 9. In other embodiments, the mode changeover switch 9 may be configured to be manually slid or manually rotated by the user to select the operation modes.

The operation panel 8 includes a mode indicator 10. The mode indicator 10 is configured to indicate an operation mode selected. In the present embodiment, the mode indicator 10 includes four LEDs and is configured to individually turn on or off these LEDs to thereby indicate the operation mode selected. In other embodiments, the mode indicator 10 may include an indicator in any other form, such as a liquid crystal display (LCD), and the operation panel 8 may be arranged at any other position in the main body 2, such as on the housing 4 or on the handgrip 5.

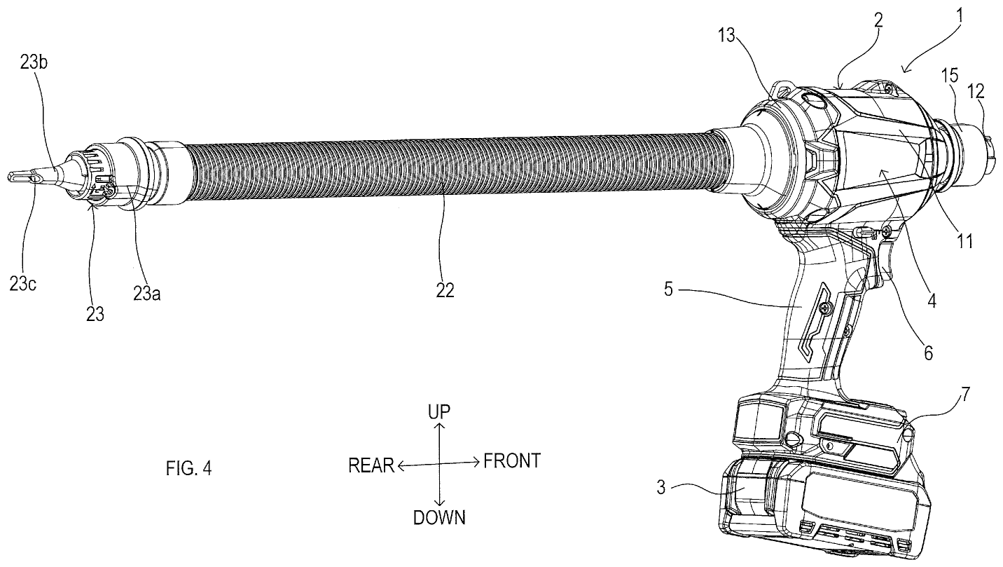

As shown in FIG. 4, the suction portion 13 of the housing 4 is configured to be detachably attached to an air suction hose 22. The air suction hose 22 includes a front end having an opening. The front end opening is configured to be attached to the suction portion 13 in such a manner that the front end opening faces the two or more first suction ports 13a. The air suction hose 22 includes a rear end having an opening. The rear end opening is connected to an air needle (or an air suction nozzle) 23. The air needle 23 is configured to be inserted into an air introduction port of a pneumatically inflated structure.

The air needle 23 includes a fitting portion 23a. The fitting portion 23a has a cylindrical shape. The fitting portion 23a includes a front end that is connected to the rear end opening of the air suction hose 22.

The air needle 23 includes an insertion portion 23b. The insertion portion 23b includes a front end that is connected to a rear end of the fitting portion 23a. The insertion portion 23b has a shape of a funnel whose diameter gradually reduces as going from the front end of the insertion portion 23b toward a rear end thereof. The rear end of the insertion portion 23b includes a second suction port 23c for introducing an air. When an air is drawn from the pneumatically inflated structure, the rear end of the insertion portion 23b (in other words, a tip of the air needle 23) is inserted into the air introduction port of the pneumatically inflated structure.

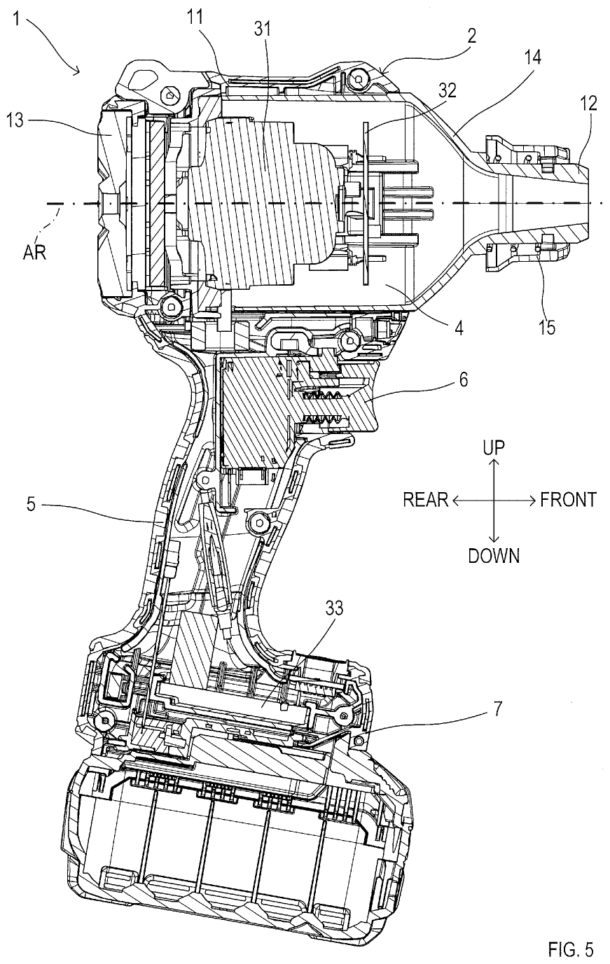

As shown in FIG. 5, the storage 11 accommodates a motor unit 31 and a fan 32 therein. The motor unit 31 is a drive source for rotationally driving the fan 32. The fan 32 is connected to the motor unit 31 so as to rotate about the axis AR. The fan 32 is configured to be rotationally driven to draw (or suck) an air through the two or more first suction ports 13a and compress the drawn air and then discharge the compressed air through the first discharge port 12a. In other words, the fan 32 is configured to generate an airflow from the two or more first suction ports 13a to the first discharge port 12a.

The blower 1 includes a control board 33 for controlling the motor unit 31. In the present embodiment, the control board 33 is accommodated in the battery attachment part 7. In other embodiments, the control board 33 may be arranged at any other position in the main body 2, such as inside the housing 4 or inside the handgrip 5.

2-2. Electrical Configuration

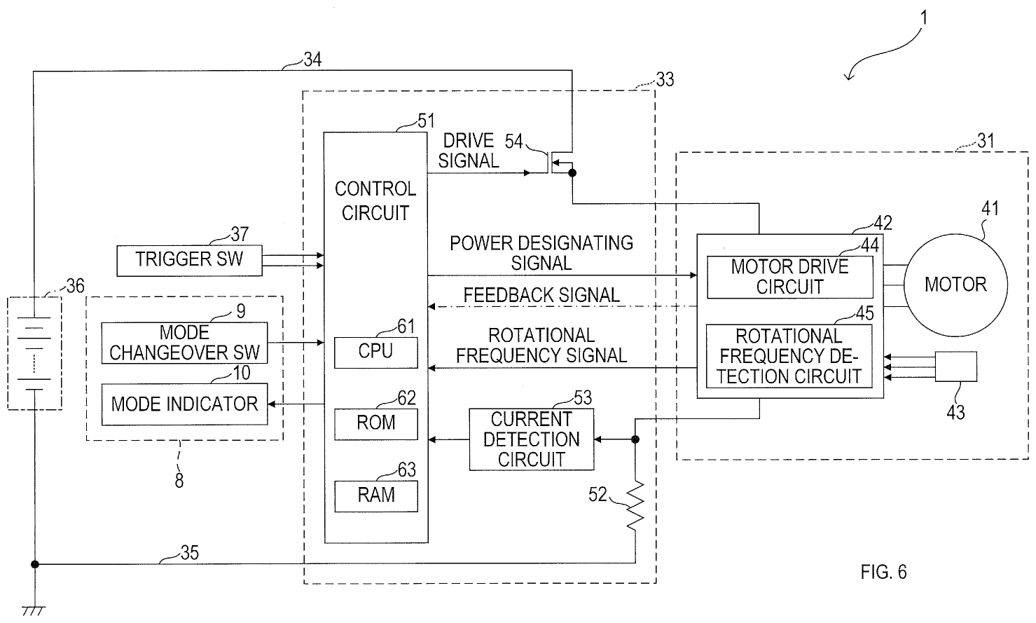

As shown in FIG. 6, the motor unit 31 includes a motor 41. In the present embodiment, the motor 41 is in the form of a three-phase brushless DC motor. In other embodiments, the motor 41 may be a motor in any other form including a single-phase brushless DC motor, a two-phase brushless DC motor, a four or more-phase brushless DC motor, a brushed DC motor, and an AC motor.

The motor unit 31 includes a drive board 42. The drive board 42 includes a motor drive circuit 44. The motor drive circuit 44 receives the DC power from a battery 36 in the battery pack 3 via a power line 34 and a ground line 35, and delivers a DC current (hereinafter, to be referred to as a drive current) to three phase windings of the motor 41, which are not shown. The power line 34 is a current path from a positive electrode of the battery 36 to the motor drive circuit 44. The ground line 35 is a current path from a negative electrode of the battery 36 to the motor drive circuit 44.

The motor drive circuit 44 receives a power designating signal output from the control board 33.

The power designating signal in the present embodiment is in the form of a pulse width modulation (PWM) signal. The power designating signal has an output duty ratio (that is, an actual duty ratio) that varies based on a magnitude of a designated power. The motor drive circuit 44 delivers, to the motor 41, a DC power (hereinafter, to be referred to as a delivered power) in accordance with the above-described power designating signal to thereby rotate the motor 41. In addition, the motor drive circuit 44 performs a constant power control that regulates a magnitude of the delivered power to be achieved to and maintained at the magnitude of the designated power. In the present embodiment, the motor drive circuit 44 performs, as the constant power control, a closed loop control (or a feedback control) for the delivered power.

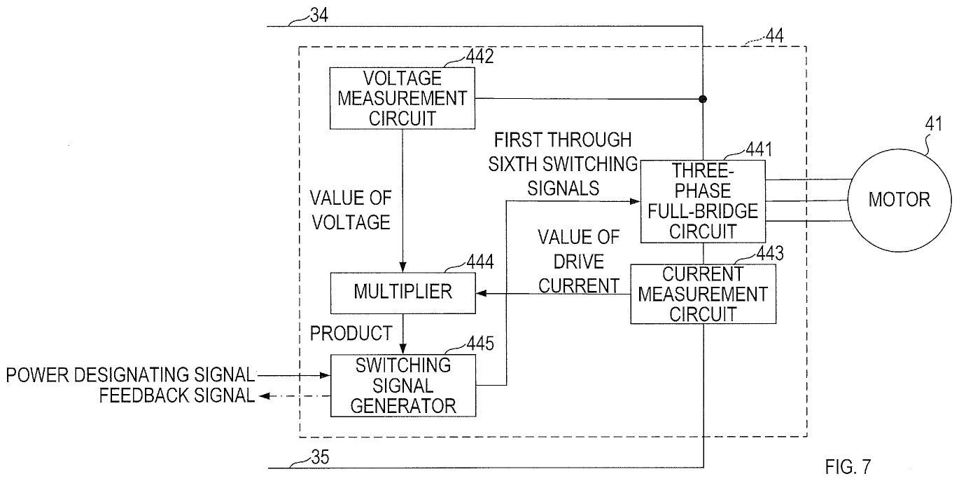

As shown in detail in FIG. 7, the motor drive circuit 44 in the present embodiment includes a three-phase full-bridge circuit 441. The three-phase full-bridge circuit 441 includes three high-side switches and three low-side switches, which are not shown. In other embodiments, the motor drive circuit 44 may include, in place of the three-phase full-bridge circuit 441, a bridge circuit in any other form (e.g. a half-bridge circuit) other than the three-phase full-bridge circuit. Alternatively, other embodiments may include, in place of the three-phase full-bridge circuit 441, a semiconductor switch in any form including a field-effect transistor (FET), a bipolar transistor, an insulated-gate bipolar transistor (IGBT), and a solid-state relay (SSR).

The motor drive circuit 44 includes a voltage measurement circuit 442.

The voltage measurement circuit 442 measures a value of the voltage of the power line 34.

The motor drive circuit 44 includes a current measurement circuit 443. The current measurement circuit 443 measures a value of the drive current flowing through the ground line 35. In other embodiments, the current measurement circuit 443 may measure a value of the drive current flowing through the power line 34.

The motor drive circuit 44 includes a multiplier 444. The multiplier 444 takes (i) the value of the voltage measured by the voltage measurement circuit 442 and (ii) the value of the drive current measured by the current measurement circuit 443, and produces their product (corresponding to the magnitude of the delivered power). The multiplier 444 may be in the form of an analog multiplier or may be in the form of a digital multiplier.

The motor drive circuit 44 includes a switching signal generator 445.

The switching signal generator 445 (i) receives the produced product and the power designating signal and (ii) generates first through sixth switching signals. The first through third switching signals correspond to the respective high-side switches, and turn on and off the corresponding high-side switches. The fourth through sixth switching signals correspond to the respective low-side switches, and turn on and off the corresponding low-side switches. The first through third switching signals and/or the fourth through sixth switching signals are in the form of PWM signals. The switching signal generator 445 determines a drive duty ratio in such a manner that an error between the produced product and the magnitude of the designated power indicated by the power designating signal is minimized (preferably to zero or near zero). The switching signal generator 445 generates the first through third switching signals and/or the fourth through sixth switching signals each having the drive duty ratio determined. Accordingly, the drive duty ratio affects an effective voltage applied to the motor 41. The switching signal generator 445 may be configured to output, to the control circuit 51, a feedback signal indicating the drive duty ratio, as indicated by the dashed line arrow. The switching signal generator 445 may include a microcomputer and/or a hardwired circuit. In other embodiments, the switching signal generator 445 may be integrated with the multiplier 444 and/or the three-phase full-bridge circuit 441.

The motor drive circuit 44 achieves the constant power control with the above-described circuit configuration. In other embodiments, the motor drive circuit 44 may perform the constant power control with a circuit configuration in any other form. In other embodiments, the power designating signal may be in the form of an analog signal having a variable voltage that varies based on the magnitude of the designated power. Alternatively, the power designating signal may be in the form of a serial communication signal indicating the magnitude of the designated power.

Referring back to FIG. 6, the motor unit 31 includes a rotation sensor 43. In the present embodiment, the rotation sensor 43 includes not-shown first through third hall elements corresponding to the respective phase windings of the motor 41. These hall elements generate first through third rotational position signals. Each of the first through third rotational position signals has a variable voltage that varies between HIGH and LOW in accordance with a rotational position of the motor 41 (more specifically, a rotational position of a not-shown rotor of the motor 41).

The drive board 42 includes a rotational frequency detection circuit 45.

The rotational frequency detection circuit 45 receives the first through third rotational position signals, and then generates and outputs a rotational frequency signal based on the rotational position signals to the control board 33. In the present embodiment, the rotational frequency signal is in the form of a pulse train. The number of pulses included in the pulse train varies in accordance with an actual rotational frequency of the motor 41. In other embodiments, the rotational frequency signal may be a signal in any other form, such as an analog signal having a variable voltage in accordance with the actual rotational frequency of the motor 41.

The control board 33 includes a control circuit 51. In the present embodiment, the control circuit 51 is in the form of a microcomputer or a micro control unit (MCU), each of which includes a CPU 61, a ROM 62, a RAM 63, and the like. Various functions of the control circuit 51 are achieved by the CPU 61 executing a program stored in the ROM 62. Due to the execution of this program, a method corresponding to the program is performed. The ROM 62 corresponds to one example of a non-transitory tangible storage medium storing the program. In other embodiments, a part of or entire functions executed by the CPU 61 may be achieved by one or more electronic components, such as a discrete device and an integrated circuit (IC), and the control circuit 51 may include one or more additional microcomputers or one or more additional MCUs, or the control circuit 51 may be in the form of a hardwired circuit.

The control board 33 includes a shunt resistor 52. The shunt resistor 52 is arranged on the ground line 35.

The control board 33 includes a current detection circuit 53. The current detection circuit 53 outputs, to the control circuit 51, a current detection signal based on a voltage across the shunt resistor 52. The current detection signal has a variable voltage that varies in accordance with the voltage across the shunt resistor 52, that is, a magnitude of the drive current flowing through the motor 41.

The control board 33 includes a switch device 54 on the power line 34.

The switch device 54 is switched between an ON state and an OFF state in accordance with a drive signal output from the control circuit 51. The switch device 54 in the ON state completes the power line 34. The switch device 54 in the OFF state interrupts the power line 34. In the present embodiment, the switch device 54 is an N-channel metal oxide semiconductor field-effect transistor (MOSFET). In other embodiments, the switch device 54 may be a semiconductor switch in any other form, such as a bipolar transistor, an IGBT, or an SSR, or may be a mechanical relay.

The blower 1 includes a trigger switch 37. The trigger switch 37 is turned on in response to the trigger 6 being pulled. The trigger switch 37 outputs a trigger-ON signal and a trigger level signal to the control circuit 51. The trigger-ON signal is a binary signal indicating whether the trigger switch 37 being turned on. The trigger level signal has a variable voltage that varies in accordance with a pulled distance of the trigger 6 (hereinafter, to be referred to as a trigger level).

In the operation panel 8, the mode changeover switch 9 outputs a mode changeover signal to the control circuit 51. The mode changeover signal is a binary signal indicating whether the mode changeover switch 9 being manually operated (in the present embodiment, whether the mode changeover switch 9 being pressed). The mode indicator 10 displays the selected operation mode on the mode indicator 10 in accordance with a display signal output from the control circuit 51. The display signal indicates the selected operation mode. In the present embodiment, the mode indicator 10 lights at least one LED that corresponds to the operation mode indicated by the display signal.

2-3. Details of Blower Control Process

Descriptions are given below of a blower control process executed by the CPU 61 of the control circuit 51. The blower control process is repeatedly executed every time a predetermined control period (for example, 1 ms) elapses.

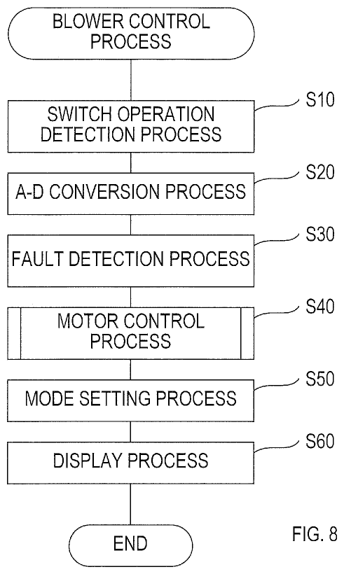

As shown in FIG. 8, upon the initiation of the blower control process, the CPU 61, in S10, executes a switch operation detection process. In the switch operation detection process, the CPU 61 detects whether the trigger switch 37 and the mode changeover switch 9 are in the ON state.

Subsequently, in S20, the CPU 61 executes an analog-to-digital (A-D) conversion process. In the A-D conversion process, the CPU 61 converts the variable voltage of the current detection signal from the current detection circuit 53 into a digital value and stores the digital value in the RAM 63. This digital value indicates the magnitude of the drive current flowing through the motor 41. The CPU 61 further converts the variable voltage of the trigger level signal from the trigger switch 37 into a digital value and stores the digital value in the RAM 63. This digital value indicates the trigger level.

Subsequently, in S30, the CPU 61 executes a fault detection process.

In the fault detection process, the CPU 61 detects a fault, such as an occurrence of an overcurrent, based on the magnitude of the drive current obtained through the A-D conversion process in S20.

Subsequently, in S40, the CPU 61 executes a motor control process, which will be described in detail later.

Subsequently, in S50, the CPU 61 executes a mode setting process. In the mode setting process, the CPU 61 switches the operation modes of the blower 1 based on the state of the mode changeover switch 9 detected through the switch operation detection process in S10.

Subsequently, in S60, the CPU 61 executes a display process. In the display process, the CPU 61 outputs the display signal to the mode indicator 10 and displays the selected operation mode on the mode indicator 10. Upon completion of the display process, the CPU 61 finishes the blower control process.

Detailed descriptions will be given below of the motor control process executed in S40.

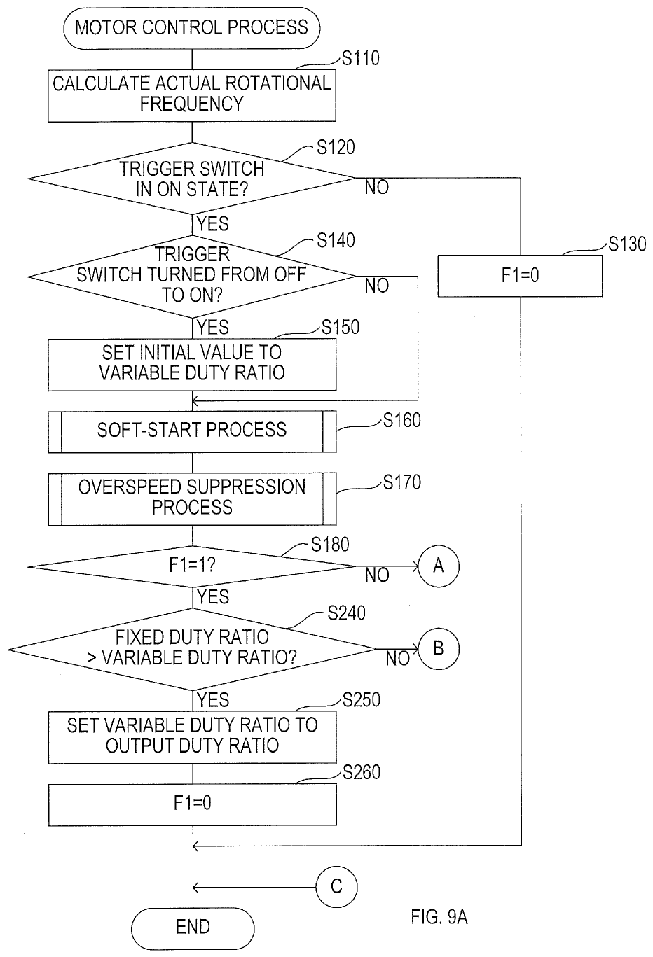

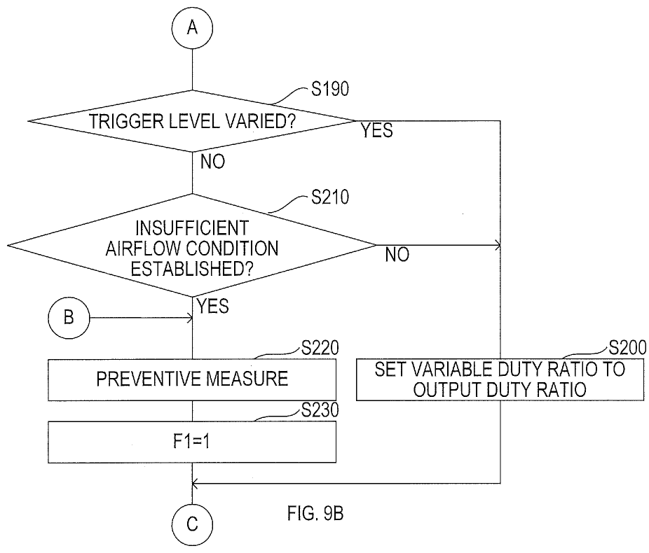

As shown in FIGS. 9A and 9B, upon the initiation of the motor control process, the CPU 61, in S110, calculates the actual rotational frequency of the motor 41 based on the rotational frequency signal output from the rotational frequency detection circuit 45 and stores the calculated actual rotational frequency in the RAM 63.

Subsequently, in S120, the CPU 61 determines whether the trigger switch 37 is in the ON state. If the trigger switch 37 is in the OFF state (S120: NO), the CPU 61, in S130, clears an insufficient airflow detection flag F1, which is stored in the RAM 63, and finishes the motor control process. The insufficient airflow detection flag F1 indicates whether an insufficient airflow from the two or more first suction ports 13a to the first discharge port 12a (or an insufficient air around the fan 32) is detected. In the present embodiment, a state in which the insufficient airflow detection flag F1 is cleared means that the insufficient airflow is not detected, whereas a state in which the insufficient airflow detection flag F 1 is set means that the insufficient airflow is detected.

If the trigger switch 37 is in the ON state in S120 (S120: YES), the CPU 61, in S140, determines whether the trigger switch 37 is switched from the OFF state to the ON state. If the trigger switch 37 is not switched from the OFF state to the ON state (S140: NO), the CPU 61 proceeds to a process of S160.

If the trigger switch 37 is switched from the OFF state to the ON state (S140: YES), the CPU 61, in S150, sets a variable duty ratio stored in the RAM 63 to an initial value and proceeds to the process of S160. The initial value is predetermined.

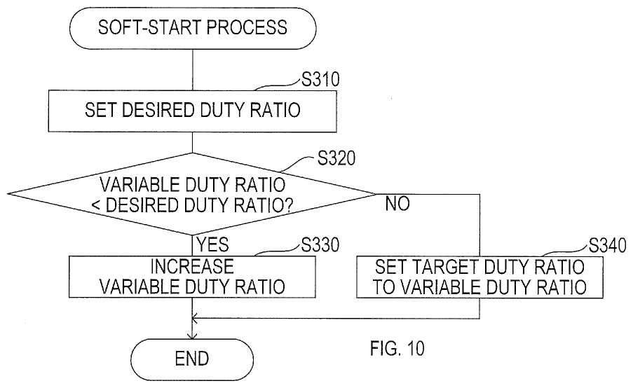

In S160, the CPU 61 executes a soft-start process shown in FIG. 10.

As shown in FIG. 10, upon the initiation of the soft-start process, the CPU 61, in S310, sets a desired duty ratio (or a target duty ratio) stored in the RAM 63 to a value that corresponds to the current trigger level and the selected operation mode.

In the present embodiment, the trigger level is set at any one of twenty-one levels (namely, levels ranging from level 0 through level 20). Specifically, level 0 corresponds to a non-pulled distance in which the trigger 6 is not pulled at all or to a small pulled distance considered as equivalent to the non-pulled distance. Level 20 corresponds to the maximum pulled distance of the trigger 6. In other embodiments, the trigger level may be set at any one of twenty or less of the levels, or at any one of twenty-two or more of the levels.

In the present embodiment, the operation modes of the blower 1 includes first-through fourth-speed modes. Every time the mode changeover switch 9 is manually operated, the CPU 61 switches the operation modes in a cyclic manner in the order of the first-speed mode, the second-speed mode, the third-speed mode, the fourth-speed mode, and back to the first-speed mode. In the first-speed mode, the maximum rotational frequency of the motor 41 is set at the lowest among the first-through fourth-speed modes. In the fourth-speed mode, the maximum rotational frequency of the motor 41 is set at the highest among the first-through fourth-speed modes. In other embodiments, the operation modes may include three or less of the speed modes or five or more of the speed modes.

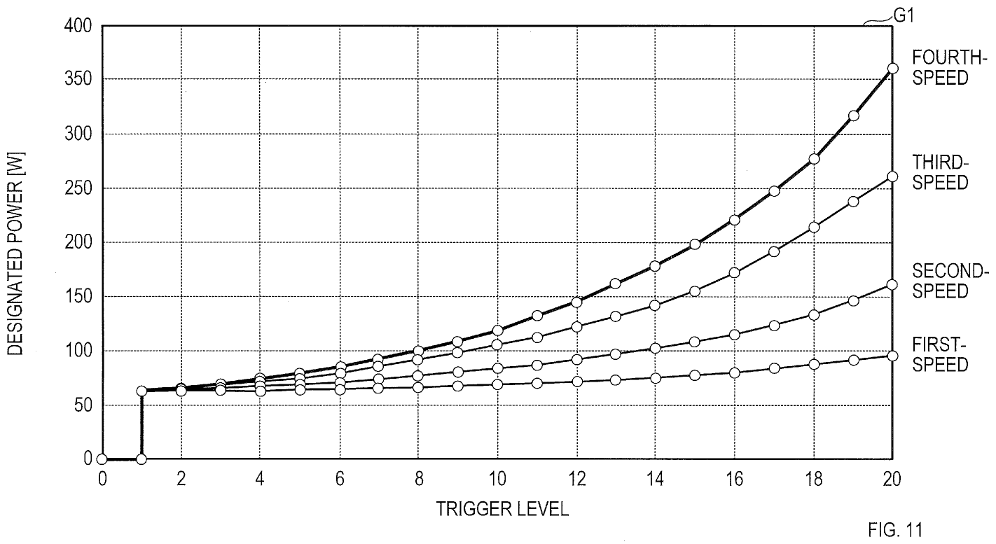

As shown in Graph G1 in FIG. 11, the maximum value of the designated power (that is, the magnitude of the designated power at the time when the trigger level is at level 20) directed to the motor drive circuit 44 is individually set with respect to each of the first- through fourth-speed modes.

In each operation mode, the designated power is set so as to be increased as the trigger level goes higher. The designated power associated with each trigger level is the smallest in the first-speed mode and is the largest in the fourth-speed mode (specifically, the first-speed mode<the second-speed mode<the third-speed mode<the fourth-speed mode).

The desired duty ratio is associated with the magnitude of the designated power. As exemplified by Graph G1, in response to the fourth-speed mode being selected and the trigger level being set at level 8, the CPU 61 sets the desired duty ratio to a value associated with 100 watts of the designated power.

Referring back to FIG. 10, upon the completion of the process of S310, the CPU 61, in S320, determines whether the variable duty ratio is smaller than the desired duty ratio.

If the variable duty ratio is smaller than the desired duty ratio (S320: YES), the CPU 61, in S330, adds a first correction value, which is preset, to the variable duty ratio to thereby increase the variable duty ratio and finishes the soft-start process.

If the variable duty ratio, in S320, is equal to or greater than the desired duty ratio (S320: NO), the CPU 61, in S340, sets the desired duty ratio to the variable duty ratio and finishes the soft-start process.

Referring back to FIGS. 9A and 9B, upon the completion of the soft-start process (S160), the CPU 61, in S170, executes an overspeed suppression process.

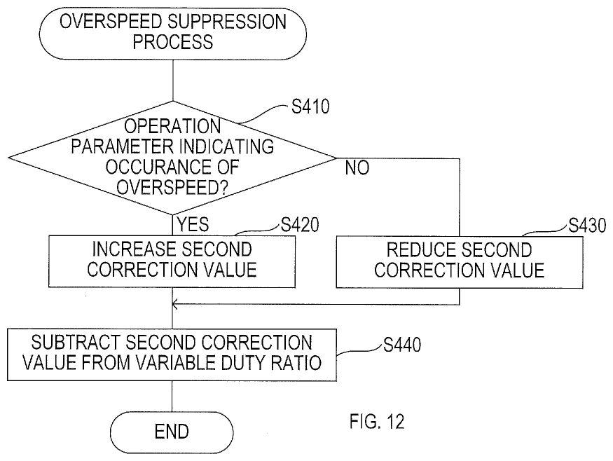

As shown in FIG. 12, upon the initiation of the overspeed suppression process, the CPU 61, in S410, compares an operation parameter with a reference value to thereby determine whether the operation parameter indicates an occurrence of an overspeed. The operation parameter is one or more parameters associated with the operation of the motor 41. The reference value in the present embodiment is an operation parameter that corresponds to the maximum rotational frequency (for example, 80,000 rpm) permissible to the motor 41. In the present embodiment, the operation parameter is the actual rotational frequency of the motor 41. In other embodiments, the operation parameter may include, in addition to or in place of the actual rotational frequency, the magnitude of the drive current and/or the drive duty ratio.

If the operation parameter indicates the occurrence of the overspeed (S410: YES), the CPU 61, in S420, adds an increment value, which is preset, to a second correction value stored in the RAM 63 to thereby increase the second correction value and then proceeds to a process of S440.

If the operation parameter does not indicate the occurrence of the overspeed (S410: NO), the CPU 61, in S430, subtracts a decrement value, which is preset, from the second correction value to thereby reduce the second correction value and then proceeds to the process of S440. In the present embodiment, the second correction value is equal to or greater than zero. Thus, in a case where a value obtained by subtracting the decrement value from the second correction value is smaller than zero (i.e. a negative value), the CPU 61 sets the second correction value to zero.

In S440, the CPU 61 subtracts the second correction value from the variable duty ratio to thereby reduce the variable duty ratio and then finishes the overspeed suppression process.

Referring back to FIGS. 9A and 9B, upon the completion of the overspeed suppression process (S170), the CPU 61, in S180, determines whether the insufficient airflow detection flag F1 is set. If the insufficient airflow detection flag F1 is cleared (S180: NO), the CPU 61, in S190, determines whether the trigger level has varied.

If the trigger level has varied (S190: YES), the CPU 61, in S200, sets the variable duty ratio to an output duty ratio of the power designating signal, outputs the power designating signal and then finishes the motor control process.

If the trigger level has not varied (S190: NO), the CPU 61, in S210, determines whether an insufficient airflow condition, which is predetermined, is established. In the present embodiment, the insufficient airflow condition is established when a variation in the operation parameter at the current period of time relative to the operation parameter prior to a specified period of time is equal to or greater than a predetermined threshold. In the present embodiment, the insufficient airflow condition is established when an increase in the actual rotational frequency is equal to or greater than the threshold. In other embodiments, the insufficient airflow condition may be established when a decrease in the drive current and/or an increase in the drive duty ratio, in addition to or in place of the increase in the actual rotational frequency, are/is equal to or greater than the corresponding thresholds/threshold.

If the insufficient airflow condition is not established (S210: NO), the CPU 61 proceeds to the process of S200. If the insufficient airflow condition is established (S210: YES), the CPU 61, in S220, performs a preventive measure for suppressing a failure in the motor 41. In the present embodiment, the CPU 61, in S220, sets the output duty ratio to a fixed duty ratio, which is preset to protect the motor 41, and outputs the power designating signal having such an output duty ratio. In other embodiments, the CPU 61, in S220, may stop the motor 41, may notify the user via the mode indicator 10 that the insufficient airflow has been detected, or may set the blower 1 to an operation mode, such as the first-speed mode or the second-speed mode, in which the maximum rotational frequency of the motor 41 is low. Upon completion of the process of S220, the CPU 61, in S230, sets the insufficient airflow detection flag F1 and then finishes the motor control process.

If the insufficient airflow detection flag F1 is set in S180 (S180: YES), the CPU 61, in S240, determines whether the fixed duty ratio is greater than the variable duty ratio.

If the fixed duty ratio is equal to or less than the variable duty ratio (S240: NO), the CPU 61 proceeds to the process of S220.

If the fixed duty ratio is greater than the variable duty ratio (S240: YES), the CPU 61, in S250, sets the variable duty ratio to the output duty ratio of the power designating signal and outputs, to the motor drive circuit 44, the power designating signal having such an output duty ratio. Subsequently, in S260, the CPU 61 clears the insufficient airflow detection flag F1 and then finishes the motor control process.

2-4. Summary of Operation

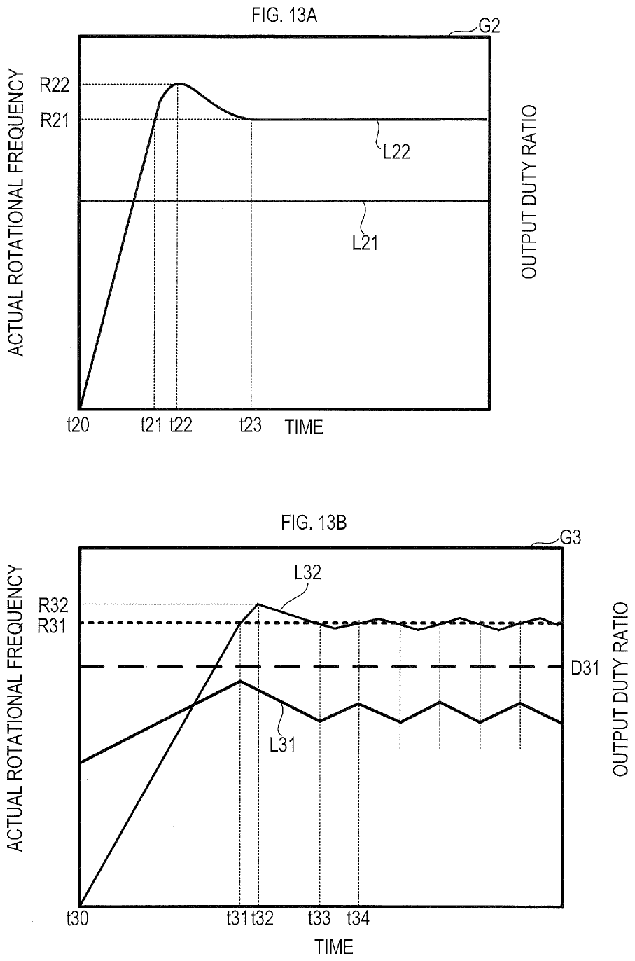

Graph G2 in FIG. 13A indicates a variation in the actual rotational frequency over time, when the power designating signal having the output duty ratio in accordance with the trigger level is output without the soft-start process being executed. Solid line L21 in Graph G2 indicates a variation in the output duty ratio over time. Solid line L22 in Graph G2 indicates the variation in the actual rotational frequency over time.

As shown in Graph G2, in this example, in response to the trigger 6 started to be pulled at Time t20, the actual rotational frequency abruptly increases. The actual rotational frequency exceeds an upper-limit rotational frequency R21 at Time t21 and reaches a peak rotational frequency R22 at Time t22. The actual rotational frequency decreases thereafter and converges to the upper-limit rotational frequency R21 at and after Time t23. The reason the actual rotational frequency converges to the upper-limit rotational frequency R21 is that an overspeed suppression function equipped on the motor unit 31 is activated.

Graph G3 in FIG. 13B indicates respective variations in the output duty ratio and in the actual rotational frequency over time in the blower 1 of the present embodiment.

In the blower 1, in response to the trigger 6 started to be pulled while the motor 41 is stopped, the soft-start process is executed and the output duty ratio gradually increases. Solid line L31 in Graph G3 indicates a variation in the output duty ratio over time. Solid line L32 in Graph G3 indicates a variation in the actual rotational frequency over time.

As shown in Graph G3, in response to the trigger 6 started to be pulled at Time t30, the output duty ratio gradually increases toward a desired duty ratio D31. Subsequently, the actual rotational frequency exceeds an upper-limit rotational frequency R31 at Time t31. In response to the actual rotational frequency having exceeded the upper-limit rotational frequency R31, the output duty ratio turns from increasing to decreasing at Time t31 when the output duty ratio does not yet reach the desired duty ratio D31. Consequently, the actual rotational frequency reaches a peak rotational frequency R32 at Time t32 and decreases thereafter.

In response to the actual rotational frequency having fallen below the upper-limit rotational frequency R31 at Time t33, the output duty ratio turns from decreasing to increasing. In response to the actual rotational frequency having reached the upper-limit rotational frequency R31 at Time t34, the output duty ratio turns from increasing to decreasing. The output duty ratio repeats increasing and decreasing in this way, and the actual rotational frequency converges to the upper-limit rotational frequency R31.

The blower 1 of the present embodiment executes the soft-start process and the overspeed suppression process, as shown in Graph G3 in FIG. 13B, whereby an overshoot of the actual rotational frequency (that is, an error between the peak rotational frequency R32 and the upper-limit rotational frequency R31) can be minimized.

In the present embodiment, the actual rotational frequency in the blower 1 needs to be high so that a sufficient airflow can be generated solely by the single fan 32. Accordingly, the actual rotational frequency is slightly lower than the reference value (for example, 80,000 rpm). In other words, the actual rotational frequency easily exceeds the reference value. Thus, the blower 1 can effectively suppress the failure in the motor 41 through the overspeed suppression process.

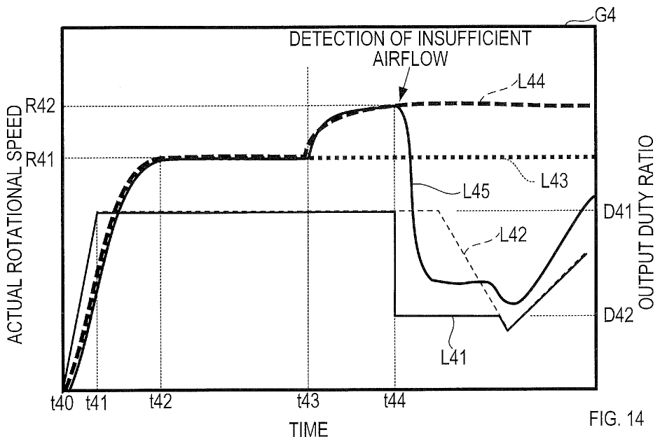

Graph G4 shown in FIG. 14 indicates respective variations in the output duty ratio and in the actual rotational frequency over time, in a case where the air suction hose 22 is attached to the suction portion 13 as shown in FIG. 4, and an air is drawn from a pneumatically inflated structure. In a case where an air is drawn from a pneumatically inflated structure in this way, when the air is completely evacuated from the pneumatically inflated structure, no air is introduced into the housing 4 through the two or more first suction ports 13a, resulting in a circumstance similar to that in which the two or more first suction ports 13a are completely closed. If the motor 41 is kept operating under such a circumstance, a temperature of the motor 41 can exceed a permissible operating temperature, and the motor 41 can fail.

Solid line L41 in Graph G4 indicates a variation in the output duty ratio over time, in a case where the insufficient airflow condition is established and the protection of the motor 41 is performed. Dotted line L42 indicates a variation in the trigger level over time. Dotted line L43 indicates a variation in the actual rotational frequency over time, in a case where the insufficient airflow condition is not established. Dotted line L44 indicates a variation in the actual rotational frequency over time, in a case where the insufficient airflow condition is established. Solid line L45 indicates a variation in the actual rotational frequency over time, in a case where the insufficient airflow condition is established and the protection of the motor 41 is performed.

As shown in Graph G4, the trigger 6 starts to be pulled at Time t40, and the trigger level gradually increases until Time t41. The trigger level is maintained thereafter.

With the variation in the trigger level as described above, the output duty ratio starts to gradually increase, at Time t40, in accordance with the trigger level, and reaches a duty ratio D41 at Time t41. The output duty ratio is maintained at the duty ratio D41 thereafter.

The actual rotational frequency starts to gradually increase at Time t40, and reaches a rotational frequency R41 at Time t42. The actual rotational frequency is maintained at the rotational frequency R41 thereafter.

In response to the insufficient airflow having occurred at Time t43, the actual rotational frequency increases despite that the trigger level and the output duty ratio are not varying.

Subsequently, in response to the insufficient airflow having been detected at Time t44 when the actual rotational frequency reaches a rotational frequency R42, the output duty ratio rapidly decreases from the duty ratio D41 to a duty ratio D42, as indicated by Solid line L41. Consequently, as indicated by Solid line L45, the actual rotational frequency rapidly decreases and the failure in the motor 41 can be suppressed.

The blower 1 configured as described above can perform a preventive measure for suppressing a failure in the motor 41 when the insufficient airflow is detected, and can suppress the failure in the motor 41.

In the blower 1, in response to no air flowing in the housing 4 and a load applied to the motor 41 decreasing, the actual rotational frequency increases due to the magnitude of the delivered power maintained at the magnitude of the designated power. The blower 1 can detect the insufficient airflow based on the increase in the actual rotational frequency.

In the motor control process, in response to the detection of the insufficient airflow, the actual rotational frequency is reduced. The blower 1 can therefore suppress the failure in the motor 41 due to the insufficient airflow.

2-5. Correspondence between Terms

In the present embodiment, at least one of the two or more first suction ports 13a corresponds to one example of the suction port in the overview of embodiments. A combination of the trigger 6 with the trigger switch 37 corresponds to one example of the manual switch in the overview of embodiments. A combination of the air needle 23 with the air suction hose 22 corresponds to one example of the attachment in the overview of embodiments.

2-6. Variations

In the above embodiment, the motor drive circuit 44 may be configured not to perform the constant power control. In such a case, in response to the occurrence of the overspeed of the motor 41, the magnitude of the drive current can decrease to the reference value or less. Accordingly, the control circuit 51 may determine, in S410 shown in FIG. 12, that the operation parameter indicates the occurrence of the overspeed, in response to the magnitude of the drive current being equal to or less than the corresponding reference value. The control circuit 51 may determine, in S210 shown in FIG. 9B, that the insufficient airflow condition is established when the variation (i.e. the decrease) in the magnitude of the drive current at the current period of time relative to the magnitude of the drive current prior to a specified period of time is equal to or greater than the corresponding threshold.

In the above embodiment, the magnitude of the designated power may be fixed.

In the above embodiment, the blower 1 may be a non-handheld blower.

2-7. Complementary Description

Two or more functions of a single element in the above embodiments may be achieved by two or more elements, or a single function of a single element may be achieved by two or more elements. Two or more functions of two or more elements in the above embodiments may be achieved by a single element, or a single function achieved by two or more elements may be achieved by a single element. A part of the configurations of the above embodiments may be omitted. At least a part of the configuration(s) of one embodiment described above may be added to or replaced with the configuration(s) of another embodiment described above.

Besides the blower 1 as described above, the present disclosure can be implemented in various forms including a system that includes the blower 1, a program for functioning a computer as a part of the blower 1, a non-transitory tangible storage medium, such as a semiconductor memory, storing such a program, and a controlling method.

What is claimed is:

1. A blower comprising:
a housing including a suction portion and a discharge portion, the suction portion and the discharge portion including a suction port and a discharge port respectively, and the suction port and the discharge port communicating an inside of the housing with an outside of the housing;
a motor in the housing;
a fan (i) in the housing and (ii) configured to be rotationally driven by the motor to thereby generate an airflow from the suction port to the discharge port;
a motor drive circuit configured (i) to receive an electric power and a power designating signal and (ii) to deliver a drive current to the motor in accordance with the power designating signal, the power designating signal being in the form of a pulse width modulation signal;
a rotational frequency detection circuit configured to output a rotational frequency signal based on a rotation of the motor, the rotational frequency signal being in the form of a pulse train that varies in accordance with an actual rotational frequency of the motor;
a current detection circuit configured (i) to detect a magnitude of the drive current and (ii) to output a current detection signal, the current detection signal having a variable voltage in accordance with the magnitude of the drive current;
a trigger configured to be pulled by a user of the blower; and
a control circuit programmed to:
calculate the actual rotational frequency based on the rotational frequency signal;
set an output duty ratio of the power designating signal based on a trigger level, the trigger level corresponding to a pulled distance of the trigger;
output, to the motor drive circuit, the power designating signal having the output duty ratio; and
detect an insufficient airflow from the suction port to the discharge port based on an operation parameter, the operation parameter being associated with an operation of the motor.

2. A blower comprising:
a housing including a suction port and a discharge port, the suction port and the discharge port communicating an inside of the housing with an outside of the housing;
a motor in the housing;
a fan (i) in the housing and (ii) configured to be rotationally driven by the motor to thereby generate an airflow from the suction port to the discharge port;
a motor drive circuit configured (i) to receive an electric power and (ii) to drive the motor based on the electric power received; and
a control circuit configured to detect an insufficient airflow from the suction port to the discharge port based on an operation parameter, the operation parameter being associated with an operation of the motor.

3. The blower according to claim 2, further comprising a rotational frequency detection circuit configured to output a rotational frequency signal based on a rotation of the motor,
wherein the rotational frequency signal varies in accordance with an actual rotational frequency of the motor,
wherein the control circuit is configured (i) to receive the rotational frequency signal and (ii) to detect the actual rotational frequency based on the rotational frequency signal, and
wherein the operation parameter includes the actual rotational frequency.

4. The blower according to claim 3, further comprising a motor unit (i) in the housing and (ii) including the motor, the motor drive circuit, and the rotational frequency detection circuit.

5. The blower according to claim 2, further comprising a current detection circuit configured (i) to detect a magnitude of a drive current flowing through the motor, and (ii) to output a current detection signal,
wherein the current detection signal varies in accordance with the magnitude of the drive current,
wherein the control circuit is configured (i) to receive the current detection signal and (ii) to detect the magnitude of the drive current, and
wherein the operation parameter includes the magnitude of the drive current.

6. The blower according to claim 2,
wherein the control circuit is configured to output a power designating signal to the motor drive circuit,
wherein the power designating signal varies in accordance with a designated power, and
wherein the motor drive circuit is configured to drive the motor in accordance with the power designating signal.

7. The blower according to claim 6,
wherein the power designating signal is in the form of a pulse width modulation signal,
wherein the control circuit is configured (i) to set an output duty ratio of the power designating signal based on a magnitude of the designated power and (ii) to output, to the motor drive circuit, the power designating signal having the output duty ratio.

8. The blower according to claim 6,
wherein the motor drive circuit is configured (i) to deliver, to the motor, an electric power designated by the power designating signal and (ii) to perform a constant power control that maintains a magnitude of the electric power delivered to the motor at a magnitude of the designated power.

9. The blower according to claim 8,
wherein the motor drive circuit is configured (i) to set a drive duty ratio based on the magnitude of the designated power and (ii) to output, to the control circuit, a feedback signal indicating the drive duty ratio,
wherein the drive duty ratio affects an effective voltage to be applied to the motor, and
wherein the operation parameter includes the drive duty ratio.

10. The blower according to claim 6, further comprising a manual switch configured to be moved by a user of the blower to designate a magnitude of an electric power to be delivered to the motor,
wherein the control circuit is configured to vary the power designating signal based on a movement of the manual switch.

11. The blower according to claim 2,
wherein the housing includes a suction portion (i) including the suction port and (ii) configured to be detachably attached to an attachment, and
wherein the attachment includes an air needle.

12. The blower according to claim 11,
wherein the attachment includes an air suction hose including:
a first end configured to be detachably attached to the suction portion; and
a second end connected to the air needle.

13. The blower according to claim 2,
wherein the control circuit is configured to control the motor via the motor drive circuit, in response to the control circuit detecting or having detected the insufficient airflow, so as (i) to reduce an actual rotational frequency of the motor or (ii) to stop the motor.

14. The blower according to claim 2, wherein the blower is in the form of a handheld blower.

15. The blower according to claim 14, further comprising a handgrip (i) extending from the housing and (ii) configured to be gripped by a user of the blower.

16. A method comprising:
driving a motor of a blower; and
detecting an insufficient airflow in a housing of the blower based on an operation parameter, the operation parameter being associated with an operation of the motor.

17. The method according to claim 16,
wherein the operation parameter includes an actual rotational frequency of the motor, a magnitude of a drive current flowing through the motor, and/or a drive duty ratio, and
wherein the drive duty ratio affects an effective voltage to be applied to the motor.

18. The method according to claim 16, further comprising, in response to the insufficient airflow being detected, reducing an actual rotational frequency of the motor, or stopping the motor.
